(19) United States
(12) Patent Application Publication
(10) Pub. No.: US 2022/0406129 A1
(43) Pub. Date: Dec. 22, 2022

(54) Methods, Apparatuses, Systems and Electronic Devices for Processing Data

(71) Applicant: SENSETIME INTERNATIONAL PTE. LTD., Singapore (SG)

(72) Inventors: Shuo Zhuang, Singapore (SG); Xinxin Wang, Singapore (SG)

(21) Appl. No.: 17/364,424

(22) Filed: Jun. 30, 2021

Related U.S. Application Data
(63) Continuation of application No. PCT/IB2021/055673, filed on Jun. 25, 2021.

(30) Foreign Application Priority Data
Jun. 18, 2021 (SG) 10202106645U

(51) Int. Cl. G07F 17/32; G06K 9/00; G06K 9/32; G06T 7/292; G06T 7/77

(52) U.S. Cl. CPC G07F 17/3239; G07F 17/3241; G06K 9/00771; G06K 9/00288; G06K 9/3233; G06T 7/292; G06T 7/77; G06T 2207/30201; G06T 2207/30232; G06T 2207/30241

(57) ABSTRACT

The embodiments of the present disclosure provide a method, apparatus, and system for processing data and an electronic device. The method includes: obtaining image collection data respectively sent by a plurality of collection devices in a target place, wherein the image collection data is obtained by the collection devices by performing image detection on one or more place images, and each of the one or more place images is an image of a region in the target place which corresponds to the collection device; obtaining region statistics data corresponding to a plurality of regions of the target place by statistical processing the image collection data; and visualizing the region statistics data.

### CROSS REFERENCE TO RELATED APPLICATION

This application is a continuation of International Application No. PCT/IB2021/055673 filed on Jun. 25, 2021, which claims priority to Singaporean Patent Application No. 10202106645U entitled “METHODS, APPARATUSES, SYSTEMS, AND ELECTRONIC DEVICES FOR PROCESSING DATA” and filed on Jun. 18, 2021, which is incorporated herein by reference in its entirety.

### TECHNICAL FIELD

The present disclosure relates to artificial intelligence technologies, and in particular to methods, apparatuses, systems, and electronic devices for processing data.

### BACKGROUND

In some regional place serving as an activity organization place, many personnel gather together to participate in some activities, for example, carry out various games in a large game place. Due to large region and many participants, it is very important to effectively manage the place. In the related art, there is no effective management approach available to perform effective management for the activities in the above place. Because the participants in the place do not clearly know about the information relating to the activities carried out in the place, they have distrustful attitude to the activities carried out in the place. Furthermore, managers also cannot obtain effective information to carry out management. These unfavorable factors are not helpful to improving the management capability for the activities in the place nor attract more people to participate in the activities in the regional place.

### SUMMARY

The embodiments of the present disclosure at least provide methods, apparatuses, systems, and electronic devices for processing data.

According to a first aspect, provided is a method of processing data, including:
obtaining image collection data respectively sent by a plurality of collection devices in a target place, wherein the image collection data is obtained by the collection devices by performing image detection on one or more place images, and each of the one or more place images is captured for a region in the target place which corresponds to one of the collection devices;
obtaining region statistics data corresponding to a plurality of the regions in the target place by statistical processing the image collection data; and
visualizing the region statistics data.

According to a second aspect, provided is a method of processing data, including:
based on one or more place images captured in a target place, obtaining image collection data corresponding to the one or more place images through image detection, wherein each of the one or more place images is captured for a region in the target place which corresponds to one of a plurality of collection devices;
sending the image collection data to a place monitoring system such that the place monitoring system statistical processes the image collection data sent by the plurality of collection devices.

According to a third aspect, provided is a system for processing data, including:
a plurality of collection devices, wherein any one of the collection devices is configured to: based on one or more place images captured in a target place, obtain image collection data corresponding to the one or more place images through image detection, wherein each of the one or more place images is an image of a region corresponding to the collection device in the target place;
a place monitoring system, configured to obtain image collection data captured by the plurality of collection devices respectively, and obtain region statistics data corresponding to a plurality of the regions of the target place by statistical processing the image collection data of the plurality of collection devices;
a visual display device, configured to visualize the region statistics data.

According to a fourth aspect, provided is an apparatus for processing data, including:
a data obtaining module, configured to obtain image collection data respectively sent by a plurality of collection devices in a target place, wherein the image collection data is obtained by the collection devices by performing image detection on one or more place images, and each of the one or more place images is captured for a region in the target corresponds to the collection devices;
a data processing module, configured to obtain region statistics data corresponding to a plurality of the regions in the target place by statistical processing the image collection data;
a visual displaying module, configured to visualize the region statistics data.

According to a fifth aspect, provided is an apparatus for processing data, including:
an image detection module, configured to, based on one or more place images captured in a target place, obtain image collection data corresponding to the one or more place images through image detection, wherein each of the one or more place images is captured for a region in the target place which corresponds to one of a plurality of collection devices;
a data sending module, configured to send the image collection data to a place monitoring system such that the place monitoring system statistical processes the image collection data sent by the plurality of collection devices.

According to a sixth aspect, provided is an electronic device, including a memory, a processor, and computer readable instructions stored in the memory, where the computer instructions are invoked by the processor to implement the method according to any one embodiment of the present disclosure.

According to a seventh aspect, provided is a computer readable storage medium storing computer programs thereon, wherein the programs are executed by a processor to implement the method according to any one embodiment of the present disclosure.

In the method, apparatus, system and electronic device for processing data according to embodiments of the present disclosure, data of a plurality of regions in a target place are collected by a place monitoring system, and region statistics data can be obtained by statistical processing the collected data and then visually displayed, so to facilitate participants in the target place to know about activity information in the target place more clearly. The activity information of a plurality of regions of the target place is transparently displayed, which helps to improve the trust of participants to the activity, thereby attracting more people to participate in the activity. At the same time, by publicly visually displayed the activity information of a plurality of regions in the target place, managers in the target place can quickly and accurately know about the activity state in the place, thereby improving the management level for the activity in the target place.

### BRIEF DESCRIPTION OF THE DRAWINGS

In order to describe the technical solutions in one or more embodiments of the present disclosure and the related art more clearly, the accompanying drawings required for descriptions of the embodiments and the related art will be briefly introduced below. Apparently, the accompanying drawings described below only involve some embodiments of one or more embodiments described herein, and those skilled in the art may also obtain other drawings based on these drawings without paying creative work.

FIG. 1 is an interior layout diagram of a target place according to at least one embodiment of the present disclosure.

FIG. 2 is a flowchart of a method of processing data according to at least one embodiment of the present disclosure.

FIG. 3 is an interaction diagram of a method of processing data according to at least one embodiment of the present disclosure.

FIG. 4 is a layout schematic diagram of a game place according to at least one embodiment of the present disclosure.

FIG. 5 is a visual display of region statistics data according to at least one embodiment of the present disclosure.

FIG. 6 is an interaction diagram of a method of processing data according to at least one embodiment of the present disclosure.

FIG. 7 is a structural diagram of an apparatus for processing data according to at least one embodiment of the present disclosure.

FIG. 8 is a structural diagram of an apparatus for processing data according to at least one embodiment of the present disclosure.

### DETAILED DESCRIPTION OF THE EMBODIMENTS

In order to help those skilled in the art to understand the technical solutions of one or more embodiments of the present disclosure better, the technical solutions of one or more embodiments of the present disclosure will be described clearly and fully below in combination with drawings in one or more embodiments of the present disclosure. It is apparent that the described embodiments are merely part of embodiments of the present disclosure rather than all embodiments. Other embodiments achieved by those of ordinary skill in the art based on the embodiments in the present disclosure without paying creative work shall all fall into the scope of protection of the present disclosure.

An embodiment of the present disclosure provides a method of processing data to perform better monitoring for an activity in a regional place and increase monitoring transparency of the activity in the regional place.

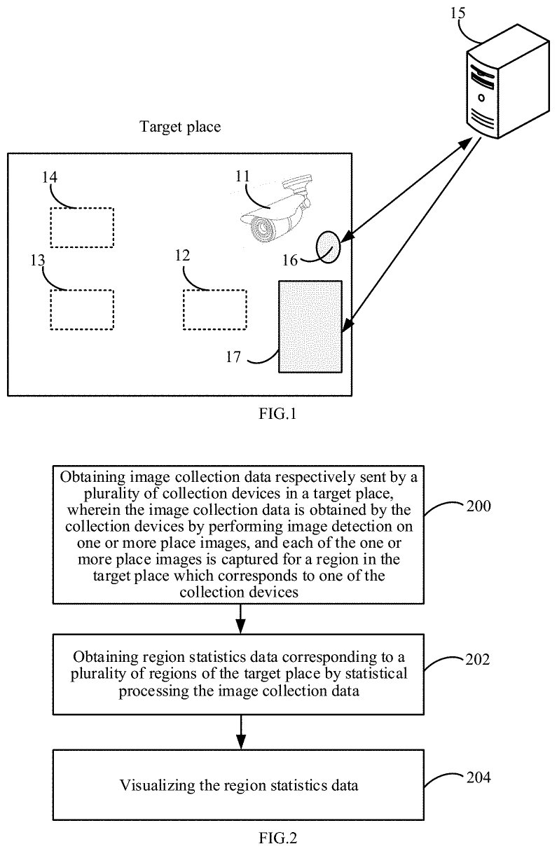

As shown in FIG. 1, a collection device 11 is disposed in a target place, and a plurality of collection devices 11 may be disposed in the entire place. Further, the target place may include a plurality of regions, for example, may include but not limited to a region 12, a region 13 and a region 14.

Illustratively, if the target place is a game place, for example, a game hall, a plurality of cameras may be disposed in the game hall to capture activity images in the game hall.

In an example, regions of the game hall may be divided based on different game regions. For example, a region may include a region for playing a game P1, in which some players playing the game P1 may gather. Another region may include another region in which some players playing a game P2 may gather. These different game regions may be called different regions as described above.

In another example, the regions may also be divided based on game tables arranged in the game hall. For example, one region where one game table is located may be called one region in which people are those playing a game at the game table; one region where another game table is located is called another region.

FIG. 2 is a flowchart of a method of processing data according to at least one embodiment of the present disclosure. The method may be performed by a place monitoring system 15 shown in FIG. 1. As shown in FIG. 2, the method may include the following steps.

At step 200, obtaining image collection data respectively sent by a plurality of collection devices in a target place, wherein the image collection data is obtained by the collection devices by performing image detection on one or more place images, and each of the one or more place images is captured for a region in the target place which corresponds to one of the collection devices.

For example, the target place is a game place. In the game place, a plurality of cameras may be disposed above or at sides of each game table to capture images in an on-going game process on the game table.

In combination with FIG. 1, a terminal device 16 may also be disposed for each game table. The terminal device 16 may receive an image captured by a camera at a side of the game table and obtain information relating to a game on the game table by performing image detection on the image. The image captured by the camera is the place image which is a game table region corresponding to the game table where the terminal device 16 is located.

For example, the terminal device 16 may detect that game coins of several preset types are placed in a region A on the game table by performing image detection on the place image captured by the camera, and thus may determine that the game on the game table is proceeding to a corresponding game stage, or determine that a number of game coins exchanged by a player participating in the game.

For another example, the terminal device 16 may also be a game process control device at the same time, which is capable of automatically switching a game process based on an image detection result, and determining that a particular round of game ends based on image detection. Thus, in a predetermined period, the terminal device 16 may automatically record a number of game rounds played in the period.

For another example, the place image captured by the camera at a side of the game table may also include an image of a player participating in the game at the game table at the same time. The terminal device 16 may also obtain identity information of each player at the game table through image detection.

The above descriptions are simple examples. In an actual implementation, the terminal device 16 may obtain various types of information such as player information, number of game rounds, game process information by performing image detection on the place image captured by the collection device, and the information is called image collection data.

The terminal device 16 may send the above image collection data to the place monitoring system 15 shown in FIG. 1. The place monitoring system 15 is equivalent to a backstage server in the game place, which may be used to further process the image collection data.

Furthermore, in this embodiment, the image collection data of the target place obtained by the place monitoring system 15 may be image collection data respectively sent by a plurality of collection devices in the target place. For example, when the target place is a game place, a plurality of collection devices in the game place may be terminal devices disposed at sides of a plurality of game tables respectively and each terminal device may obtain image collection data by performing image detection on place images captured by cameras at a side of the game table and then report these image collection data to the place monitoring system 15. These image collection data include data of a plurality of regions, and, for example, the plurality of regions may be a plurality of game table regions.

At step 202, obtaining region statistics data corresponding to a plurality of regions of the target place by statistical processing the image collection data.

In this step, the place monitoring system may statistically process for the received image collection data. The statistical processing herein mainly refers to that summarization is performed for the image collection data of a plurality of regions.

For example, it is assumed that in the acquired image collection data, the game players at one game table include U1 and U2, and the game players at another game table include U3, U4, U5 and U6. In this case, the place monitoring system can determine by counting that the game players at the two game tables are 6 persons in total, two of whom are at one game table and four at another game table.

For another example, if in the acquired image collection data, the terminal device reports a number of game rounds completed at each game table, the place monitoring system may determine a total number of game rounds played in a particular period.

For another example, the place monitoring system may even simply gather the image collection data of a plurality of regions in a place rather than perform any summing statistics processing on the received image collection data. For example, the place monitoring system is equivalent to one summarization center of image collection data of a plurality of regions, the image collection data captured by each region is sent to the place monitoring system, and thus the place monitoring system obtains the data of each region in a centralized manner.

Because the place monitoring system receives the image collection data of a plurality of regions in the target place, all the above data may be called region statistics data. These region statistics data may be data obtained by performing the above summing calculation or be an entire set of the data of the plurality of regions.

At step 204, visualizing the region statistics data.

For example, in combination with FIG. 1, the place monitoring system 15 sends the region statistics data to a visual display device 17 in the target place, so that the visual display device 17 is caused to display the region statistics data on a screen. For example, the visual display device 17 may be a large screen disposed in a hall of the game place to display the region statistics data so as to allow a player in the game place to view in real time, or a manager in the game place to view.

In the method of processing data in the embodiment of the present disclosure, the place monitoring system collects data of a plurality of regions of the target place and visualizes the obtained region statistics data. In this way, the participants in the place can know about activity information in the place more clearly and conveniently. The activity information of a plurality of regions of the place is transparently displayed which helps to improve the trust of the activity participants in the activity, thereby attracting more people to participate in the activity. At the same time, by publicly visualizing the entire activity information of a plurality of regions in the place, the manager in the place will be helped to more quickly and accurately know about the activity state in the place, thereby improving the management level of the place for the activity.

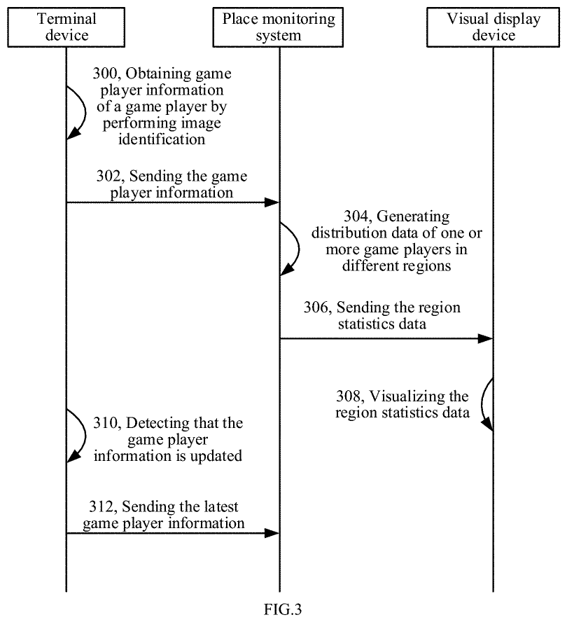

FIG. 3 is a method of processing data according to at least one embodiment of the present disclosure. The statistical calculation of a player distribution in a game place is taken as an example in the embodiment.

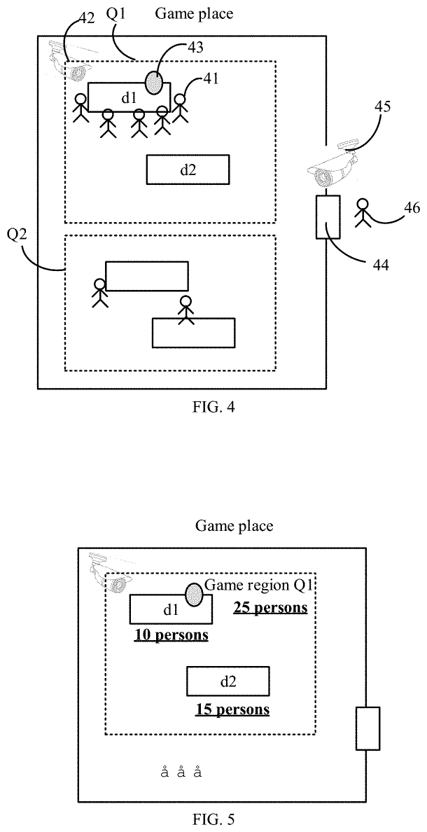

FIG. 4 is a layout schematic diagram of a game place according to this embodiment. As shown in FIG. 4, the game place includes a plurality of game regions, such as a game region Q1 and a game region Q2. Each game region may include a plurality of game tables, for example, the game region Q1 may include a game table d1, and a game table d2. There may be many game spectators and game participants around each game table, for example, several players 41 shown in FIG. 4. A camera 42 may be disposed around each game table (for example, above or at a side) to capture an image of an on-going game on the game table, and transmit the captured image to a terminal device 43 disposed at the game table. The terminal device 43 acquires information relating to the on-going game on the game table by image detection. The monitoring configuration similar to the above may also be adopted for other game tables and will not be described again.

How to collect and obtain the player distribution of the game place will be described below.

Firstly, in combination with FIG. 4, a camera 45 is disposed at an entry 44 of the game place to capture images of players 46 entering the game place. For example, most players entering the game place have handled face registration in advance and become a registered member of the game place. When a member enters the game place, the identity of the member can be identified through face image collection and face recognition of the camera 45. For example, the camera 45 may obtain the following information: “the member with ID 001 enters the game place at a particular time”. If an unregistered player enters, the player will be assigned an ID randomly because the player cannot be recognized in the database of face recognition.

The above identity recognition of the players entering the game place will have the following usages.

On the one hand, all recognized players entering the game place may be classified as one set, and player distribution detection can be performed subsequently based on the set. For example, if the set is called “entering player set”, the terminal device at the game table may perform comparison in the entering player set based on the face images captured by cameras subsequently so as to quickly find the identities of players at the game table, to improve recognition efficiency of players in the game place.

On the other hand, the identities identified upon entry into the game place are transmitted to the place monitoring system so that the place monitoring system counts a number of entering players in each period. For example, the number of players entering the game place on Dec. 1, 2020 is calculated to be S1. The player entry statistics based on time period may be provided to help the manager in the place to know the number of players participating in an activity in the place.

In the game place, the camera disposed at a side of each game table in the place may capture images of players gathering around the game table, and the camera can capture the face images of the players who are around the game table, are participating in the game at the game table and are not participating in the game at the game table. In an example, the terminal device 43 may perform face recognition comparison based on the face images, for example, perform face recognition comparison with the images in the above “entering player set”, or with the images in a full face database, so as to obtain the identities of the players at the game table. For example, the terminal device 43 of the game table d1 in FIG. 4 may obtain the following player identity information: “001, 002, 023, 052 . . . ”.

Based on this, the data processing flow is described below in combination with FIG. 3.

At step 300, the terminal device obtains game player information of a game player by performing image detection on a place image, where the game player information includes region information about where the game player at the game table is located in the game place.

The game player is a general concept. For example, all players gathering around the game table where the terminal device is located are called game player regardless of whether the player actually participates in a game. The game players may watch the game or may participate in the game in person.

The game player information may include but not limited to: identity information of a game player, a table type of a game table where the game player is located, and region information about where the game table belongs. The identity information is obtained by comparing the face images captured by the cameras and the player images of the players who have handled face registration. The table type of the game table and the region information about where the game table belongs may be pre-stored in the terminal device. For example, one terminal device is placed on each game table. In this case, the information of the game table where the terminal device is located, such as the table type of the game table, and the region information of the region (for example, the region Q1 to which the game table d1 belongs as shown in FIG. 4) to which the game table belongs may be pre-stored in the terminal device.

At step 302, the terminal device sends the game player information to the place monitoring system.

For example, the terminal device may send the above obtained game player information to the place monitoring system. The terminal device at a side of each game table in the game place may report the game player information of the game player at the game table where the terminal device is located to the place monitoring system. The place monitoring system may receive the game player information of different regions in the game place.

The terminal device may send the above game player information by a message queue (MQ), and the place monitoring system may monitor the message queue to perform information collection.

At step 304, the place monitoring system generates distribution data of one or more game players in different regions based on the above region information as region statistics data.

In an embodiment, the place monitoring system may generate the number of the game players at each game table with each game table as a statistics dimension according to the game player information reported by the terminal device of each game table. For example, the game players at the game table d1 are 10 persons, and the game players at the game table d2 are 15 persons.

In another embodiment, the place monitoring system may determine the number of the game players in each game region with each game region as a statistics dimension according to the game player information reported by the terminal device of each game table. Specifically, summing is performed for the numbers of the game players at various game tables in each game region. For example, the game players in the game region Q1 may be “the number of the game players at the game table d1”+“the number of the game players at the game table d2”, totaling 25 persons.

Alternatively, statistics may be computed based on the above two dimensions. In this case, the place monitoring system can obtain the number of game players at each game table and the number of game players in each game region.

In another embodiment, the game player information reported by the terminal device may also include player identifier of the game player, for example, ID “001”. The region information therein may also include at least one of: a region identifier of the region and region time information about when a game player is in the region. For example, the region information reported by the terminal device 43 disposed at the game table d1 may include that the region where the terminal device 43 is located is the game table d1 region and the region time information that the game player with ID “001” is at the game table d1 may be that the game player with ID “001” arrives at the game table d1 at 13:10, or may be that the game player with ID “001” is at the game table d1 during the period of from 13:10 to 15:30. The region information may include at least one of the above region and region time information.

Based on acquiring the player identifier of the game player, the region, and the region time information and the like, the place monitoring system may determine a trajectory of the game player in the game place, or analysis of a stay time in the game place. For example, a plurality of collection devices (e.g. a terminal device at a side of the game table) all report their respective image collection data to the place monitoring system, and the place monitoring system may obtain a plurality of pieces of game player information corresponding to a same player identifier from the image collection data sent by the plurality of collection devices, where each piece of game player information is sent by one of the collection devices. For example, the image collection data sent by the two collection devices “game table d1” and “game table d2” include the same game player ID “001”. Thus, the place monitoring system may know the moving trajectory and/or trajectory time of the game player “001” in different game table regions in the game place, for example, the game player “001” is at the game table d1 in the period of from 13:10 to 15:30 and at the game table d2 in the period of from 16:00 to 17:00. At least one of the above moving trajectory and/or trajectory time may be obtained, for example, the moving trajectory of the game player “001” may be obtained as “game table d1−game table d2”, or a sum of the moving trajectory and the trajectory time of the game player “001” may be obtained as “at the game table d1 in the period of from 13:10 to 15:30” which is described above.

At step 306, the place monitoring system sends the region statistics data to a visual display device, where the region statistics data includes a number of game players in each of the different regions in the game place.

For example, the visual display device may be an information display device arranged in the game place and have a display screen. The region statistics data sent to the visual display device by the place monitoring system may include a number of game players in each of the different regions.

The number of game players in each of the different regions herein may include a number of game players at each game table in the place or a number of game players in each game region in the place.

In an actual implementation, the region statistics data may be sent to the visual display device through a websocket interface. The visual display device may construct a visual UI based on Echart frontend technology.

At step 308, the visual display device visualizes the region statistics data on the screen.

In this step, the data of the regions may be visualized on the screen of the visual display device. Taking the above game player information as an example, the screen of the visual display device may display identifiers of different regions of the game place, and display a number of game players corresponding to each region, and may also display representation information corresponding to the number of game players.

As shown in FIG. 5, a layout of the game place may be displayed, for example, identifiers of different regions included in the game place, and the number of game players in each region are displayed. For example, the different regions may be different game regions or different game tables in a game region. Further, the number of game players corresponding to each region is displayed, for example, the game players at the game table d1 are 10 persons, and the game players at the game table d2 are 15 persons, and thus there are a total of 25 persons in the game region Q1.

Furthermore, the representation information corresponding to the number of game players may also be displayed. The representation information herein may be information capable of indicating a degree of a number of game players. For example, it may be preset that when a number of game players is in the range of 1-10, the region where the game players are located is denoted by green; and, when a number of game players is in the range of 10-30, the region where the game players are located is denoted by orange, and so on. Therefore, the screen can display a color corresponding to the number of game players in a corresponding region. In this way, upon seeing the color, the range where the number of persons in the corresponding region is in can be roughly known and whether the number of persons is large or small can be further known. Alternatively, the color and the number may be displayed in the corresponding region at the same time. The above color may be referred to as representation information. It is understood that the color representation is merely illustrative, and the number of persons can also be represented in another manner, for example, different numbers may be represented by different heights of a histogram.

At step 310, the terminal device detects that game player information of a game player at a game table corresponding to the collection device is updated.

The cameras at the game table may always perform image capture. Players in the game place have a large flow, and the game players at the game table may also change frequently, for example, some players go away to another game table, or new players come to the game table.

The terminal device may detect whether game players at the game table where the terminal device is located are updated through image detection. For example, the game player identity information identified by the terminal device in last image detection includes 001, 002, and 003, while the game player identity information obtained in this image detection includes 001, 002, 003 and 004. It means that the game players are updated, that is, there is new game player 004 coming to the game table. The terminal device may determine whether the game players are updated by comparing with the player identity information obtained.

At step 312, the terminal device obtains the latest game player information and sends it to the place monitoring system, where the game player information includes region information about where the game player is located in the game place.

In this step, the terminal device may obtain the latest game player information, including the region information about where the game player is located in the game place, for example, identity information of game player, table type of a game table where a game player is located, and region information about where the game table belongs. Then, the terminal device may send the latest game player information to the place monitoring system which can replace original game player information of the game table. The terminal device may synchronize the game player information to the place monitoring system periodically, or may trigger synchronization update to the place monitoring system in real time in response to update of the game player.

For example, a mapping relationship between a game table and game player identity information corresponding to the game table is stored in the place monitoring system, for example, the mapping relationship may include “the game player identity information of game players at the game table d1 includes 001, 002, and 003”. Afterwards, the place monitoring system receives, from the terminal device, the latest game player information including “the game player identity information is 001, 002, 003, and 004; a table identifier of a game table where the terminal device is located is d3; a table type of the game table; a game region to which the game table d3 belongs is Q2”. Thus, the place monitoring system determines through comparison that the game player identity information of the game players at the game table d3 is updated, and then replaces the original identity information 001, 002 and 003 with the new identity information 001, 002, 003 and 004.

The place monitoring system may synchronously update a pattern displayed on the display screen of the visual display device based on the updated game player information. For example, the number of game players in the corresponding region on the display screen is updated to the latest number of game players.

In the data processing method of the embodiments of the present disclosure, player information of different regions in the place is collected and then region statistical computation and visualization are performed for the player information of different regions to help moving persons in the place to quickly know about the player distribution of different regions in the place and have an improved trust in the activities in the place and also help the manager in the place to perform better management for the activities in the place, for example, assign more managers to the region with more persons so as to increase the service level of the region.

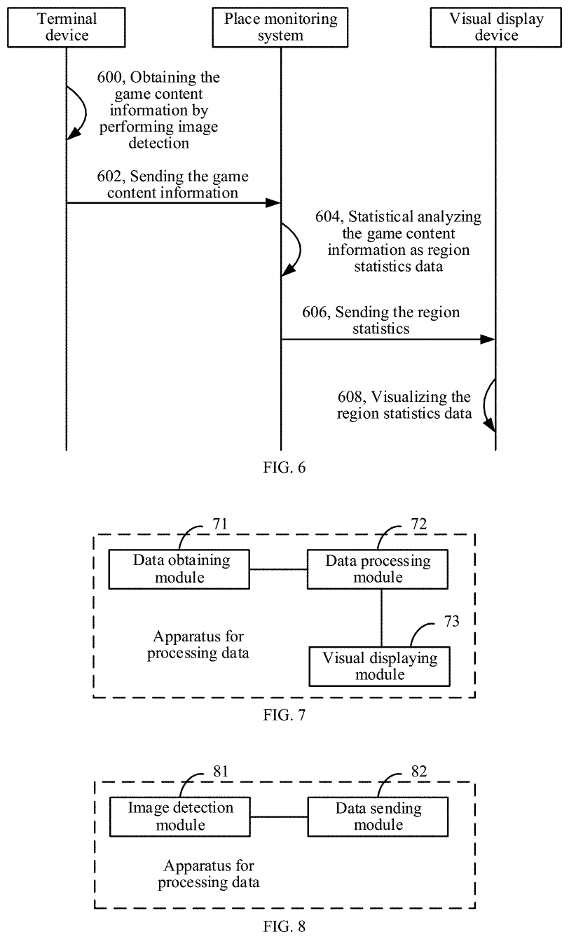

FIG. 6 shows a method of processing data according to at least one embodiment of the present disclosure. For example, in this embodiment, game content information of the game place is obtained, for example, game results of different regions or some data in a game process are obtained. It is noted that the distribution data of place players obtained in the above embodiment and the game content information obtained in this embodiment both are merely illustrative place information available. In an actual implementation, other data information than the above information may also be obtained as long as it is the region information.

Still taking the game place shown in FIG. 4 as an example, a plurality of game players may gather around a game table to watch or participate in the on-going game on the game table. Therefore, the terminal device may report both the game player information and the game content information to the place monitoring system. Descriptions are made below in combination with FIG. 6.

At step 600, the terminal device may obtain the game content information by performing image detection on a place image.

The game content information may include at least one of: a region where a game is located, a game type, game process data, game result data and game player information of the game player participating in the game.

The region where the game is located may include: a game table where the game is located, and a game region to which the game table belongs. Furthermore, various types of games may be carried out in the game place. Thus, the terminal device may know which type of game is going on currently on the game table where the terminal device is located. For this purpose, a manager at the game table may perform setting on the terminal device or the terminal device obtains the game type based on image detection.

The above game process data may be some information in a game process obtained by the terminal device through image detection. Specifically, when a game at the game table is in progress, the camera above or at a side of the game table may capture images of the game table in real time, and the terminal device may obtain relevant information through image detection.

For example, if a game player participating in the game needs to exchange his own first object for a second object to be used in the game to participate in the game using the second object during a game process, the player may place the first object on the game table, a manager who is in charge of managing and controlling the game on the game table may exchange the equivalent second object for the player based on the first object placed by the player. The camera at the game table may capture the first object placed by the player on the game table and the exchanged second object, and the terminal device may obtain information such as the number of the first objects, the face value of the first object, the face value of the second object or the number of the second objects or the like through image detection. The information may be called game process data, that is, information relating to object value and the like collected in a game process.

The above game result may be, for example, that a user A participating in the game wins, or a user B participating in the game wins and the like. The game result data may be operated and set by a game manager at the game table through the terminal device. For example, if the game manager depresses a button a on the terminal device, it indicates that the user A participating in the game wins, and if the game manager depresses a button b on the terminal device, it indicates that the user B participating in the game wins. Alternatively, the terminal device may also detect a win or lose result of the game by identifying an image captured by the camera.

In addition, the game player information of the game player participating in a game refers to persons actually participating in the game. There may be several persons, for example, 10 persons, around a game table, but only some of them actually participate in the game. In a game process, those players participating in a game usually have body actions on the game table which can be photographed by cameras above and at a side of the game table. For example, a participant may take a game coin on the game table, which will be captured by the cameras. The terminal device may associate the player whose body action is photographed with a human face stored in the database to identify the identity of the player through face recognition, so as to obtain the game player information of the game player participating in the game. The game player information may include player ID.

At step 602, the terminal device sends the game content information to the place monitoring system.

For example, the terminal device may send the above game content information to the place monitoring system. The terminal device at each game table in the game place can report the game content information of the game table where the terminal device is located to the place monitoring system. Thus, the place monitoring system can receive the game content information of different regions in the game place.

For example, the game content information sent by the terminal device may include at least part of a game type, a game table where a game is located, a game region to which the game table belongs, game process data, game result data and game player information of a game player participating in the game. Further, the game content information may also include a game identifier. Each round of game may have its own corresponding game ID.

The terminal device may send the above game content information by a message queue (MQ), and the place monitoring system may monitor the message queue to perform information collection.

In an actual implementation, when detecting that a target game on a game table corresponding to the collection device ends, the terminal device may report the game content information of the target game to the place monitoring system.

At step 604, the place monitoring system statistical analyzes the game content information as region statistics data based on at least one of time dimension and region dimension in combination with the above game content information.

In an embodiment, the place monitoring system may determine the number of exchanged second objects with time as statistics dimension based on the game content information reported by the terminal device of each game table. For example, the place monitoring system may determine a total number of first objects used by a player to exchange the second objects in the entire game place on a day or in a month.

In another embodiment, the place monitoring system may determine a number of game rounds and corresponding game results in the entire game place or in each game region with region as statistics dimension according to the game content information reported by the terminal device of each game table. For example, a total number of game rounds in a particular period in each game region can be calculated, or a probability that a player wins in a particular period at a game table or in a game region can be calculated. The monitoring system can determine the information such as the number of game rounds in different periods (hour/day/month).

At step 606, the place monitoring system sends the region statistics data to the visual display device.

For example, the visual display device may be an information display device arranged in the game place and have a display screen. The region statistics data sent to the visual display device by the place monitoring system may, for example, include statistics of a total number of game rounds of each game table or different game regions.

In an actual implementation, the region statistics data may be sent to the visual display device through a websocket interface. The visual display device may construct a visual UI based on Echart frontend technology.

At step 608, the visual display device visualizes the region statistics data on the screen.

In this step, the data of the regions may be visualized on the screen of the visual display device. Taking display of the above game content information as an example, the screen of the visual display device may display identifiers of different regions of the game place, and display a total number of game rounds corresponding to each region, and may also display game result data.

For example, in an actual display, the game content information of various rounds of games may be scrolling-displayed on the display screen of the visual display device. N (N is a natural number) pieces of game content information may be set to be displayed on the screen according to a time sequence. The latest game content information will be displayed at the bottom of the screen so as to push the oldest game content information at the top of the screen out of the screen, thereby ensuring that N pieces of game content information are always displayed on the screen. Each piece of game content information may include a game ID, a game type, a game table where a game is located, a game region to which the game table belongs, game result data and game process data and the like.

In the data processing method of the embodiments of the present disclosure, game content information of different regions in the place is collected and then region computation and visualization are performed for the game content information of different regions to help the moving persons in the place to quickly know about the game progress of different regions in the place. Thus, the transparency of the game activities is improved, the trust of the game players in the activities in the place is increased, and the manager in the place is helped to perform better management for the activities in the place.

In an example, the data processing method of the embodiments of the present disclosure can be applied to a game place. The target place is the game place, and the collection device may be a terminal device AI Node disposed at a side of a game table.

Specifically, the terminal device disposed at the game table obtains image collection data in the game place by performing image detection on a place image captured by a camera disposed at a side of the game table, and then sends the image collection data to the place monitoring system in the game place.

The image collection data obtained by the AI Node may include players at each game table. These players may be players actually participating in a game in the game place or players watching the game at the game table. The information such as player identifier of the game players at the game table, game table information, region information about where the game table belongs may be sent to the place monitoring system in the game place through MQ.

Alternatively, the image collection data obtained by AI Node may also include the game content information of various types of games going on the game table. In a game place monitoring example, the game process data may be a number of articles and a number of bought game coins when a player uses articles to exchange game coins. The game result data may be data such as player winning. The player identifier of a game player participating in a game on the game table may also be obtained.

The above image collection data may be visualized on the large screen in the game place. For example, a region layout of the game place and player distribution of each game region may be displayed. Further, the information such as game result of each round of game, game type and region where the game is located can be scrolling-displayed on the screen.

In the method of the embodiments of the present disclosure, the game place may be helped to complete collection and visualization of data of the game place so that the circumstances of the game place become transparent to visually reflect the environment of the game place. In this way, the trust of the players in the game place for the game place is increased, and the workers in the game place are helped to visually see how many persons are to be assigned to which region, and which region has potential service hazard. Therefore, the workers can know the risk in advance and improve the service level of the game place and the player experiences in the game place.

An embodiment of the present disclosure provides a system for processing data. The system includes a plurality of collection devices, a place monitoring system and a visual display device. Any one of the plurality of collection devices can, based on one or more place images collected in a target place, obtain image collection data corresponding to the one or more place images through image detection, where each of the one or more place images is captured for region in the target place which corresponds to the collection device. For example, the target place may be a game place, the collection device may be a terminal device disposed at a side of a game table, and the place image may be an image of a game table region captured by the camera disposed at a side of the game table, which is sent to the terminal device through the camera and then processed by the terminal device through image detection.

The place monitoring system in the system can obtain image collection data obtained by the plurality of collection devices respectively and then obtain region statistics data corresponding to a plurality of regions of the target place by statistical processing the image collection data of the plurality of collection devices. Furthermore, the place monitoring system may send the region statistics data to the visual display device which visualizes the region statistics data. The detailed descriptions of the collection devices, the place monitoring system and the visual display device in the system for processing data may be referred to any one method embodiment of the present disclosure and will not be repeated herein.

FIG. 7 is a structural schematic diagram of an apparatus for processing data according to at least one embodiment of the present disclosure. The apparatus may be configured to implement the embodiment of any data processing method of the present disclosure. For example, the apparatus may be applied to a place monitoring system. As shown in FIG. 7, the apparatus may include a data obtaining module 71, a data processing module 72, and a visual displaying module 73.

The data obtaining module 71 is configured to obtain image collection data respectively sent by a plurality of collection devices in a target place, wherein the image collection data is obtained by the collection devices by performing image detection on one or more place images, and each of the one or more place images is captured for a region in the target place which corresponds to one of the collection devices.

The data processing module 72 is configured to obtain region statistics data corresponding to a plurality of regions of the target place by statistical processing the image collection data.

The visual displaying module 73 is configured to visualize the region statistics data.

In an example, when used to obtain the image collection data respectively sent by a plurality of collection devices in the target place, the data obtaining module 71 is configured to: receive game player information sent by the plurality of collection devices respectively, wherein the game player information includes region information about where game player is located in a game place; the target place is the game place.

When used to obtain the region statistics data corresponding to a plurality of regions of the target place by statistical processing the image collection data, the data processing module 72 is configured to: based on the region information, generating distribution data of one or more game players in different regions as the region statistics data.

In an example, the game player information includes: player identifier of the game player; the region information includes at least one of: a region identifier of the region corresponding to the collection device and region time information about when the game player is in the region; when used to, based on the region information, generate the distribution data of one or more game players in different regions as the region statistics data, the data processing module 72 is configured to: obtain a plurality of pieces of game player information corresponding to a same player identifier from the image collection data sent by the plurality of collection devices, wherein each piece of game player information is sent by one collection device; based on the region and/or region time information in the plurality of pieces of game player information, obtain moving trajectory of the game player with the player identifier in different regions of the game place, and/or, trajectory time of the game player in different regions of the game place.

In an example, when used to obtain the image collection data respectively sent by a plurality of collection devices in the target place, the data obtaining module 71 is configured to: receive game content information sent by the plurality of collection devices respectively, wherein the game content information includes at least one of: a region where a game is located, a game type, game process data, game result data, and game player information of the game player participating in the game.

When used to obtain region statistics data corresponding to a plurality of regions of the target place by statistical processing the image collection data, the data processing module 72 is configured to: statistical analyze the game content information based on at least one of time dimension and region dimension.

In an example, when used to visualize the region statistics data, the visual displaying module 73 is configured to: send the region statistics data to a visual display device in the target place such that the visual display device is caused to display the region statistics data on a screen.

FIG. 8 is a structural schematic diagram of an apparatus for processing data according to at least one embodiment of the present disclosure. The apparatus may be used to implement the embodiment of any data processing method in the present disclosure. For example, the apparatus may be applied to a terminal device. As shown in FIG. 8, the apparatus may include an image detection module 81 and a data sending module 82.

The image detection module 81 is configured to, based on one or more place images captured in a target place, obtain image collection data corresponding to the one or more place images through image detection, wherein each of the one or more place images is captured for a region in the target place corresponds to one of a plurality of collection devices.

The data sending module 82 is configured to send the image collection data to a place monitoring system such that the place monitoring system statistical processes the image collection data sent by the plurality of collection devices.

In an example, when used to send the image collection data to the place monitoring system, the data sending module 82 is configured to: in response to detecting that a target game on a game table corresponding to the collection device is ended, obtain game content information of the target game, wherein the game content information includes at least one of a region where the target game is played, a game type of the target game, game progress data of the target game, and game result data of the target game and game player information of a game player participating in the target game; send the game content information to the place monitoring system, wherein the target place is the game place.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

The embodiments of the present disclosure further provide a computer readable storage medium, storing computer programs thereon, wherein the programs are executed by a processor to implement the data processing method according to any one embodiment of the present disclosure.

The embodiments of the present disclosure further provide an electronic device, including: a memory, a processor and computer readable instructions stored in the memory, wherein the computer instructions are invoked by the processor to implement the data processing method according to any one embodiment of the present disclosure.

In the present disclosure, the word “and/or” refers to at least one of two. For example, “A and/or B” may include three options: A, B and “A and B”.

Different embodiments in the present disclosure are described in a progressive manner. Each embodiment focuses on the differences from other embodiments with those same or similar parts among the embodiments referred to each other. Particularly, since data processing device embodiments are basically similar to the method embodiments, the device embodiments are briefly described with relevant parts referred to the descriptions of the method embodiments.

Specific embodiments of the present disclosure are described above. Other embodiments not described herein still fall within the scope of the appended claims. In some cases, the actions or steps recorded in the claims may be performed in a sequence different from the embodiments to achieve a desired result. Further, the processes shown in drawings do not necessarily require a particular sequence or a continuous sequence to achieve the desired result. In some embodiments, a multi-task processing and parallel processing are possible and may also be advantageous.

The embodiments of the subject and functional operations described in the present disclosure may be achieved in the following: a digital electronic circuit, a tangible computer software or firmware, a computer hardware including a structure disclosed in the present disclosure or a structural equivalent thereof, or a combination of one or more of the above. The embodiment of the subject described in the present disclosure may be implemented as one or more computer programs, that is, one or more modules in computer program instructions encoded on a tangible non-transitory program carrier for being executed by or controlling a data processing apparatus. Alternatively or additionally, the program instructions may be encoded on an artificially-generated transmission signal, such as a machine-generated electrical, optical or electromagnetic signal. The signal is generated to encode and transmit information to an appropriate receiver for execution by the data processing apparatus. The computer storage medium may be a machine readable storage device, a machine readable storage substrate, a random or serial access memory device, or a combination of one or more of the above.

The processing and logic flows described in the present disclosure may be executed by one or more programmable computers executing one or more computer programs to perform operations based on input data and generate outputs to execute corresponding functions. The processing and logic flows may be further executed by a dedicated logic circuit, such as a field programmable gate array (FPGA) or an application specific integrated circuit (ASIC), and the apparatus may be further implemented as the dedicated logic circuit.

A computer suitable for executing computer programs may include, for example, a general-purpose and/or special-purpose microprocessor, or any other type of central processing unit. Generally, the central processing unit receives instructions and data from a read-only memory and/or random access memory. Basic components of a computer may include a central processing unit for implementing or executing instructions and one or more storage devices for storing instructions and data. Generally, the computer may further include one or more mass storage devices for storing data, such as magnetic disks, magneto-optical disks or optical disks, or the computer is operably coupled to this mass storage device to receive data therefrom or transmit data thereto, or both. However, the computer does not necessarily have such device. In addition, the computer may be embedded in another device, such as a mobile phone, a personal digital assistant (PDA), a mobile audio or video player, a game console, a global positioning system (GPS) receiver, or a portable storage device, e.g., a universal serial bus (USB) flash drive, and so on.

Computer readable media suitable for storing computer program instructions and data may include all forms of non-volatile memories, media and memory devices, such as semi-conductor memory devices (e.g., Erasable Programmable Read-Only Memory (EPROM), Electrically Erasable Programmable Read-Only Memory (EEPROM) and flash memory device), magnetic disks (e.g., internal hard disk or removable disk), magneto-optical disks, and CD ROM and DVD-ROM disks. The processor and the memory may be supplemented by or incorporated into a dedicated logic circuit.

Although many specific implementation details are included in the present disclosure, these details should not be construed as limiting any scope of the present disclosure or the claimed scope, but are mainly used to describe the features of specific embodiments of the present disclosure. Certain features described in several embodiments of the present disclosure may also be implemented in combination in a single embodiment. On the other hand, various features described in the single embodiment may also be implemented separately or in any appropriate sub-combination in several embodiments. In addition, although the features may function in certain combinations as described above and even be initially claimed as such, one or more features from the claimed combination may be removed from the combination in some cases, and the claimed combination may refer to a sub-combination or a variation of the sub-combination.

Similarly, although the operations are described in a specific order in the drawings, this should not be understood as requiring these operations to be performed in the shown specific order or in sequence, or requiring all of the illustrated operations to be performed, so as to achieve a desired result. In some cases, multi-task processing and parallel processing may be advantageous. In addition, the separation of different system modules and components in the above embodiments should not be understood as requiring such separation in all embodiments. Further, it is to be understood that the described program components and systems may be generally integrated together in a single software product or packaged into a plurality of software products.

Therefore, the specific embodiments of the subject are already described, and other embodiments are within the scope of the appended claims. In some cases, actions recorded in the claims may be performed in a different order to achieve the desired result. In addition, the processing described in the drawings is not necessarily performed in the shown specific order or in sequence, so as to achieve the desired result. In some implementations, multi-task processing and parallel processing may be advantageous.

The foregoing disclosure is merely illustrative of preferred embodiments of the present disclosure but not intended to limit the present disclosure, and any modifications, equivalent substitutions, adaptations thereof made within the spirit and principles of one or more embodiments in the present disclosure shall be encompassed in the scope of protection of one or more embodiments in the present disclosure.

1. A method of processing data, comprising:
obtaining image collection data respectively sent by a plurality of collection devices in a target place, wherein the image collection data is obtained by the collection devices performing image detection on one or more place images, and each of the one or more place images is captured for a region in the target place which corresponds to one of the collection devices;
obtaining region statistics data corresponding to a plurality of the regions in the target place by statistical processing the image collection data; and
visualizing the region statistics data.

2. The method according to claim 1, wherein,
the target place is a game place;
the collection devices comprise a terminal device disposed on a side of each of game tables in the game place, and each of the game tables is correspondingly provided with one or more of the collection devices; and
each of the regions indicates a game table region corresponding to one of the game tables on which the terminal device is disposed.

3. The method according to claim 1, wherein
the target place is a game place;
obtaining the image collection data respectively sent by the plurality of collection devices in the target place comprises:
receiving game player information respectively sent by the plurality of collection devices, wherein the game player information comprises region information about where a game player is located in the game place;
obtaining the region statistics data corresponding to a plurality of the regions in the target place by statistical processing the image collection data comprises:
generating, based on the region information, distribution data of one or more game players in different regions as the region statistics data.

4. The method according to claim 3, wherein
the game player information comprises a player identifier of the game player;
the region information comprises at least one of: a region identifier of the region, and region time information about when the game player is in the region;
generating, based on the region information, the distribution data of the one or more game players in different regions as the region statistics data comprises:
obtaining a plurality of pieces of game player information corresponding to a same player identifier from the image collection data sent by the plurality of collection devices, wherein each piece of the game player information is sent by one of the collection devices;
obtaining, based on at least one of: the region identifier and the region time information in each of the plurality of pieces of game player information, at least one of:
a moving trajectory of the game player with the player identifier in different regions of the game place, and
trajectory time of the game player in different regions of the game place.

5. The method according to claim 3, wherein
the distribution data of the one or more game players in different regions comprises a number of game players in each of the different regions of the game place;
visualizing the region statistics data comprises:
for each of the different regions of the game place, visualizing a region identifier of the region and at least one of:
the number of game players in the region, and
representation information corresponding to the number of game players in the region.

6. The method according to claim 1, wherein
the target place is a game place;
obtaining the image collection data respectively sent by the plurality of collection devices in the target place comprises:
receiving game content information sent by the plurality of collection devices respectively, wherein the game content information comprises at least one of:
a region where a game is played,
a game type,
game progress data,
game result data, and
game player information of a game player participating in the game;
obtaining region statistics data corresponding to a plurality of the regions in the target place by statistical processing the image collection data comprises:
statistical analyzing the game content information based on at least one of time dimension and region dimension.

7. The method according to claim 1, wherein visualizing the region statistics data comprises:
sending the region statistics data to a visual display device in the target place such that the visual display device is caused to display the region statistics data on a screen.

8. A method of processing data, comprising:
obtaining, based on one or more place images captured in a target place, image collection data corresponding to the one or more place images through image detection, wherein each of the one or more place images is captured for a region in the target place which corresponds to one of a plurality of collection devices;
sending the image collection data to a place monitoring system such that the place monitoring system is caused to statistical process the image collection data sent by the plurality of collection devices.

9. The method according to claim 8, wherein
the target place is a game place;
sending the image collection data to the place monitoring system comprises:
obtaining, in response to detecting that a target game on a game table corresponding to the collection device is ended, game content information of the target game, wherein the game content information comprises at least one of:
a region where the target game is played,
a game type of the target game,
game progress data of the target game,
game result data of the target game, and
game player information of a game player participating in the target game;
sending the game content information to the place monitoring system.

10. The method according to claim 8, wherein
the target place is a game place;
sending the image collection data to the place monitoring system comprises:
obtaining, in response to that game player information of a game player at a game table corresponding to the collection device is updated, the game player information corresponding to the game table, wherein the game player information comprises region information about where the game player is located in the game place;
sending the game player information to the place monitoring system.

11. A system for processing data, comprising:
a plurality of collection devices, wherein any one of the collection devices is configured to: based on one or more place images captured in a target place, obtain image collection data corresponding to the one or more place images through image detection, wherein each of the one or more place images is captured for a region in the target place which corresponds to the collection device in the target place;
a place monitoring system, configured to obtain image collection data collected by the plurality of collection devices respectively, and obtain region statistics data corresponding to a plurality of the regions in the target place by statistical processing the image collection data of the plurality of collection devices;
a visual display device, configured to visualize the region statistics data.
